(19) United States
(12) Patent Application Publication
(10) Pub. No.: US 2007/0281848 A1
(43) Pub. Date: Dec. 6, 2007

(54) Dielectric material used on high power stainless steel plates and the preparation method thereof

(76) Inventors: Shenghong Wu, Dongguan (CN); Taijun Deng, Dongguan (CN)

Correspondence Address: BYIP, LTD., P.O. BOX 1484, GENERAL POST OFFICE, HONG KONG, CN

(21) Appl. No.: 11/790,485

(22) Filed: Apr. 25, 2007

(30) Foreign Application Priority Data
Apr. 29, 2006 (CN) 200610035305.1

(51) Int. Cl. C03C 10/14; C03C 10/12

(52) U.S. Cl. 501/4; 501/7; 65/33.1; 65/33.4

(57) ABSTRACT

The present invention relates to a dielectric material used on high power stainless steel plates and the preparation method thereof. The present invention provides a dielectric material used on high power stainless steel plates, which does not need printing and sintering many times, and has a superior insulating ability and a good printing performance. The present invention firstly prepares the dielectric material: according to the weight-percent proportions preparing the nonmetallic materials and stirring the mixture evenly, then sintering it to obtain the microcrystalline glass power, then adding crude materials and water to obtain the slurry-like dielectric material, which is ready to be sprayed on the stainless steel plates, and the insulation and voltage resistant insulation dielectric layer is obtained after sintering. The present invention greatly increases the production efficiency, saves energies and production costs, and the production process is simple and does not need dustproof operations and environmental requirements.

### CROSS REFERENCE

The present application claims priority from Chinese Patent Application No. 200610035305.1 filed Apr. 29, 2006.

### FIELD OF INVENTION

The present invention relates to a dielectric material used on stainless steel plates of heating components, particularly, to a dielectric material used on high power stainless steel plates and the preparation method thereof.

### DESCRIPTION OF RELATED ARTS

In the present market, there are positive-temperature-coefficient thermistor (called PTC for short) heating components and carbon-paste electrothermal-film heating components, but they have many limitations for their slow heating up, low power and low temperature. There are also many high power and high temperature resistance wire heating components and Ni—Cr heating components, but they have many limitations in their application fields for their short lives, low thermal efficiency, unsafety and so on. Afterwards many overseas companies researched and developed many kinds of electronic pastes, and applied them on nonmetallic materials such as ceramic base materials and high polymer materials and so on. But on the whole these electronic pastes can not be used on the nonmetallic materials as the thick film electric components required by high power, for the main problems are that the nonmetallic materials would rupture because of the overlarge power density and could be damaged during installation. And the metal base materials have a good heat-resistance and a vibration-proof ability, but the expansion coefficients of the metal materials do not match those of the commonly used electronic pastes, and there are a series of other problems such as oxidizations of some metals. Though some overseas companies like DuPont Company also developed some dielectric pastes which match the stainless steel plates, but their expensive prices and low production efficiencies let people flinch from them.

Using stainless steel plates as the base material can not only prevent the metal materials from oxidization, but also require their dielectric materials some requirements different from other dielectric materials, such as: 1. art performance requirements: Because the products belong to the high power and high temperature type, the dielectric materials are requested to have a comparatively high sintering temperature and match the conventional resistance pastes, then the sintering temperature should be above 850° C. 2. In order to satisfy the electric performance requirements, the dielectric materials are requested to have a big insulation resistance and withstand a comparatively high voltage, normally above 3000V. 3. Physical performance aspect: The dielectric materials are requested to have an expansion coefficient and heat-resistant and vibration-proof performance matching the stainless steel plates. 4. The dielectric materials are requested to have no lead and tin and so on required by the European Union about the environment.

Based on the above requirements, many electronic pastes basically are unable to satisfy these requirements. Although DuPont Company and other companies also studied some dielectric pastes, which match the stainless steel plates, but their expensive prices and requiring printing many times and adding organic cementing agents and low production efficiencies let people flinch from them.

### SUMMARY OF THE PRESENT INVENTION

According to the problems existed in the prior arts, the technical problem the present invention aims to settle is to provide a dielectric material used on high power stainless steel plates, which does not need printing and sintering many times, has a superior insulating ability and a good printing performance, and can satisfy the requirement of the large scale production.

In order to realize the above aim, the kind of dielectric materials used on high power stainless steel plates of the present invention is made by the technical solution as follows:

A dielectric material used on high power stainless steel plates comprises mainly a microcrystalline glass. That dielectric material is prepared by melting the nonmetallic oxides according to the proportions to obtain the microcrystalline glass powder, and adding water into the microcrystalline glass power, wherein the proportion of the glass power to the water is (50˜90):(50˜10), and the nonmetallic oxides comprise the following components by weight-percent proportions as follows:

| | |
|---|---|
| SiO₂: | 50˜80%; |
| Al₂O_{3:} | 0.5˜20%; |
| CoO: | 0.5˜8%; |
| CaO: | 1˜20%; |
| TiO₂: | 0.5˜15%; |
| ZrO_{2:} | 5˜30%; |
| ZnO: | 1˜10%; |
| Na₂O: | 1˜5%; |
| K₂O: | 1˜15%; |
| BaO: | 0.5˜10%; |
| B₂O_{3:} | 0.5˜15%. |

The preparation method of the dielectric material used on high power stainless steel plates of the present invention comprises the following steps:

1. Firstly preparing the dielectric material, according to the weight-percent proportions preparing the following nonmetallic materials:

| | | | |
|---|---|---|---|
| SiO₂: | 50˜80%; | Al₂O₃: | 0.5˜20%; |
| CoO: | 0.5˜8%; | CaO: | 1˜20%; |
| TiO₂: | 0.5˜45%; | ZrO₂: | 5˜30%; |
| ZnO: | 1˜10%; | Na₂O: | 1˜5%; |
| K₂O: | 1˜15%; | BaO: | 0.5˜40%; |
| B₂O₃: | 0.5˜15%. | | |

Stirring the mixture evenly, then putting it into the high temperature box furnace to sinter, the sintering temperature is 1350˜1550° C., for 2˜5 hours, then pouring it into water for water quench, then loading the obtained microcrystalline glass into the ball mill for grinding to obtain the microcrystalline glass power.

2. Then adding crude materials and water into the microcrystalline glass power to obtain the slurry-like dielectric material, wherein the proportion of the microcrystalline glass power and the water proportion is (50˜90):(50˜10).

3. Loading the dielectric material into the storage jar of the spray gun, and then the dielectric material being ready to spray.

4. Drying the dielectric material sprayed on the stainless steel plates, then sintering at above 850° C. in the net belt stove to obtain the insulation dielectric layer with a voltage resistance of above 3000V, namely the insulation dielectric layer being the heat-resistant, vibration-proof, anti-high temperature and high insulating insulation dielectric layer needed by many kinds of high powers.

The present invention can settle the above all technical problems, and has following merits compared to the traditional dielectric pastes used on the stainless steel plates:

1. The present invention does not need to print and sinter many times, which can greatly increase the production efficiency, save energies and production costs.

2. The present invention does not need to add organic solvents, and is obtained just by adding water into the microcrystalline glass power to obtain the slurry-like dielectric material, which saves the costs greatly.

3. With the spray production craft, the day productivity is big, which can increase the production efficiency and the production benefit greatly, and satisfy the requirements of the large scale production.

4. The present invention does not need dustproof operations. The traditional printing craft needs an especially clean environment, normally above 10,000-level, moreover the silk net and the steel plate also need to be cleaned many times to remove the dust, thus with a little carelessness it is very easy to obtain unqualified insulation and pressure-resistant products and a low production qualified rate, but the present dielectric material adopts the spray operation, which is simple and no environmental requirements, and all products are qualified.

5. The present invention has a high intensity of insulation and voltage resistance, perhaps above 3000V, but the traditional printing paste only has a voltage resistance of about 1500V.

### DETAILED DESCRIPTION OF THE PREFERRED EMBODIMENT

The present invention is further exemplified by reference to the examples. A dielectric material used on high power stainless steel plates is mainly prepared by sintering and melting the nonmetallic oxides at high temperature to obtain the microcrystalline glass powder, and adding water into the microcrystalline glass power, wherein the proportion of the glass power to the water is (50˜90):(50˜10), and that dielectric material comprises mainly the microcrystalline glass, wherein the nonmetallic oxides comprise the following components by weight-percent proportions as follows:.

| | |
|---|---|
| SiO₂: | 50˜80%; |
| Al₂O₃: | 0.5˜20%; |
| CoO: | 0.5˜8%; |
| CaO: | 1˜20%; |
| TiO₂: | 0.5˜15%; |
| ZrO₂: | 5˜30%; |
| ZnO: | 1˜10%; |
| Na₂O: | 1˜5%; |
| K₂O: | 1˜15%; |
| BaO: | 0.5˜10%; |
| B₂O₃: | 0.5˜15%. |

The preparation method of the present invention is: melting the nonmetallic oxides according to the proportions to obtain the microcrystalline glass powder, and adding water into the microcrystalline glass power to obtain the dielectric material.

The preparation method of the dielectric material used on high power stainless steel plates of the present invention comprises the following steps:

1. Firstly preparing the dielectric material, according to the weight-percent proportions preparing the following nonmetallic materials:

| | | | |
|---|---|---|---|
| SiO₂: | 50˜80%; | Al₂O₃ | 0.5˜20%; |
| CoO: | 0.5˜8%; | CaO: | 1˜20%; |
| TiO₂: | 0.5˜15%; | ZrO₂: | 5˜30%; |
| ZnO: | 1˜10%; | Na₂O: | 1˜5%; |
| K₂O: | 1˜15%; | BaO: | 0.5˜10%; |
| B₂O₃: | 0.5˜15%. | | |

Stirring the mixture evenly, then putting it into the high temperature box furnace to sinter, the sintering temperature is 1350˜1550° C., for 2˜5 hours, then pouring it into water for water quench, then loading the obtained microcrystalline glass into the ball mill for grinding to obtain the microcrystalline glass power.

2. Then adding crude materials and water into the microcrystalline glass power to obtain the slurry-like dielectric material, wherein the proportion of the microcrystalline glass power and the water proportion is (50˜90):(50˜10).

3. Loading the dielectric material into the storage jar of the spray gun, and then the dielectric material being ready to spray.

4. Drying the dielectric material sprayed on the stainless steel plates, then sintering at above 850° C. in the net belt stove to obtain the insulation dielectric layer with a voltage resistance of above 3000V, namely the insulation dielectric layer being the heat-resistant, vibration-proof, anti-high temperature and high insulating insulation dielectric layer needed by many kinds of high powers.

The embodiment described above is exemplary only and not intended to be limiting. With the technical content disclosed in the present invention, one skilled in the art will carry out other part-changed or modified equivalent embodiments without departure from the content of the technical features of the present invention. Therefore these embodiments still belong to the scope of the technical features of the present invention.

What is claimed is:

1. A dielectric material used on high power stainless steel plates characterized in that the dielectric material comprises mainly a microcrystalline glass, and the dielectric material is prepared by melting the nonmetallic oxides according to the proportions to obtain the microcrystalline glass powder, and adding water into the microcrystalline glass power, wherein the proportion of the glass power to the water is (50˜90):(50˜10), and the nonmetallic oxides comprise the following components by weight-percent proportions as follows:

| | |
|---|---|
| SiO₂: | 50˜80%; |
| Al₂O₃: | 0.5˜20%; |
| CoO: | 0.5˜8%; |
| CaO: | 1˜20%; |
| TiO₂: | 0.5˜15%; |
| ZrO₂: | 5˜30%; |
| ZnO: | 1˜10%; |
| Na₂O: | 1˜5%; |
| K₂O: | 1˜15%; |
| BaO: | 0.5˜10%; |
| B₂O₃: | 0.5˜15%. |

2. A preparation method of a dielectric material used on high power stainless steel plates characterized in that the preparation method comprises the following steps:
1.) Firstly preparing the dielectric material, according to the weight-percent proportions preparing the following nonmetallic materials:

| | | | |
|---|---|---|---|
| SiO₂: | 50˜80%; | Al₂O₃: | 0.5˜20% ; |
| CoO: | 0.5˜8%; | CaO: | 1˜20%; |
| TiO₂: | 0.5˜15%; | ZrO₂: | 5˜30%; |
| ZnO: | 1˜10%; | Na₂O: | 1˜5%; |
| K₂O: | 1˜15%; | BaO: | 0.5˜10%; |
| B₂O₃: | 0.5˜15%. | | |

Stirring the mixture evenly, then putting it into the high temperature box furnace to sinter, the sintering temperature is 1350˜1550° C., for 2˜5 hours, then pouring it into water for water quench, then loading the obtained microcrystalline glass into the ball mill for grinding to obtain the microcrystalline glass power;
2.) Then adding crude materials and water into the microcrystalline glass power to obtain the slurry-like dielectric material, wherein the proportion of the microcrystalline glass power and the water proportion is (50˜90):(50˜10);
3.) Loading the dielectric material into the storage jar of the spray gun, and then the dielectric material being ready to spray;
4.) Drying the dielectric material sprayed on the stainless steel plates, then sintering at above 850° C. in the net belt stove to obtain the insulation dielectric layer with a voltage resistance of above 3000V, namely the insulation dielectric layer being the heat-resistant, vibration-proof, anti-high temperature and high insulating insulation dielectric layer needed by many kinds of high powers.
